(19) United States
(12) Patent Application Publication
(10) Pub. No.: US 2026/0189402 A1
(43) Pub. Date: Jul. 2, 2026

(54) JUST-IN-TIME SELECTIVE LOADING OF CRYPTOGRAPHIC SIGNATURES

(71) Applicant: ServiceNow, Inc., Santa Clara, CA (US)

(72) Inventors: Huiqing Wen, San Diego, CA (US); Marvin Torio, Chula Vista, CA (US); Shantanu Sardesai, Sammamish, WA (US); Sainadh Ainala, Bellevue, WA (US)

(21) Appl. No.: 19/006,969

(22) Filed: Dec. 31, 2024

(51) Int. Cl. H04L 9/32

(52) U.S. Cl. CPC H04L 9/3247

(57) ABSTRACT

Embodiments of the subject technology relate to systems, methods, and computer-readable media for just-in-time signature loading to selectively load a specific cryptographic signature needed to authenticate a software asset being loaded/executed during a runtime of an application associated with the software asset. The systems and techniques described herein can selectively load specific cryptographic signatures as needed during runtime, rather than loading all cryptographic signatures associated with the application during runtime, including any cryptographic signatures that may not be needed to run a particular instance or portion of the application (such as the cryptographic signatures of any software assets that are not used/loaded with the application and may not need to be authenticated).

### BACKGROUND

### 1. Technical Field

The present disclosure generally relates to signature loading for authenticating a software asset during runtime of an application associated with the software asset, and more specifically to selectively loading cryptographic signatures for authenticating the software.

### 2. Introduction

Cryptographic signatures of software assets are often used to verify the integrity and authenticity of the software assets before loading/running the software assets. Some applications may include many software assets (e.g., files, modules, functions, code portions, scripts, etc.), each signed with cryptographic techniques/mechanisms. Typically, when an application is executed, the cryptographic signatures of all the software assets of the application are loaded to a database during runtime of the application, and each respective cryptographic signature is verified ahead of execution. However, the process of loading all cryptographic signatures to the database during runtime can reduce performance of the application, as it can introduce delays in the loading and verification process. Moreover, a large number of cryptographic signatures can consume an excessive amount of storage space.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1A illustrates a diagram of an example cloud computing architecture, according to some examples of the present disclosure;

FIG. 1B is a block diagram illustrating an example network architecture that can be used to implement one or more embodiments, components, devices, nodes, systems, instances, and/or portions of the example cloud computing architecture, according to some examples of the present disclosure;

FIG. 2 illustrates a block diagram of an example process for performing just-in-time signature loading, according to some examples of the present disclosure;

FIG. 3 illustrates a block diagram of an example process for generating cryptographic signatures of one or more software assets that can be used to verify the integrity and authenticity of the one or more software assets, according to some examples of the present disclosure;

FIG. 4 illustrates a block diagram of an example process for selective signature verification, according to some examples of the present disclosure;

FIG. 5 illustrates a block diagram of an example process for performing just-in-time signature loading to selectively load one or more specific cryptographic signatures to authenticate a software asset, according to some examples of the present disclosure;

FIG. 6 illustrates an example processor-based system with which some embodiments of the subject technology can be implemented, according to some examples of the present disclosure.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

As discussed previously, cryptographic signatures of software assets are often used to verify the integrity and authenticity of the software assets before loading/running the software assets. Some applications may include many software assets (e.g., files, modules, functions, code portions, scripts, etc.), each signed with cryptographic techniques/mechanisms. Typically, when an application is executed, the cryptographic signatures of all the software assets of the application are loaded to a database during runtime of the application, and each respective cryptographic signature is verified ahead of execution. However, the process of loading all cryptographic signatures to the database during runtime can reduce performance of the application, as it introduces delays in the loading and verification process. Moreover, a large number of cryptographic signatures can consume an excessive amount of storage space.

The systems, apparatuses, processes (also referred to as methods), and computer-readable media (collectively referred to as “systems and techniques”) described herein can use just-in-time signature loading to selectively load a specific cryptographic signature needed to authenticate a software asset being loaded/executed during a runtime of an application associated with the software asset. This way, the systems and techniques described herein can selectively load specific cryptographic signatures as needed during runtime, rather than loading all cryptographic signatures associated with the application during runtime, including any cryptographic signatures that may not be needed to run a particular instance or portion of the application (such as the cryptographic signatures of any software assets that are not used/loaded with the application and may not need to be authenticated). Compared to known techniques, which include loading all cryptographic signatures at runtime, the just-in-time signature loading of the current disclosure improves performance of the application, reduce latencies in authenticating software assets being loaded/executed, and reduce the storage space used to store cryptographic signatures in the database when running the application, all without compromising security when running the application.

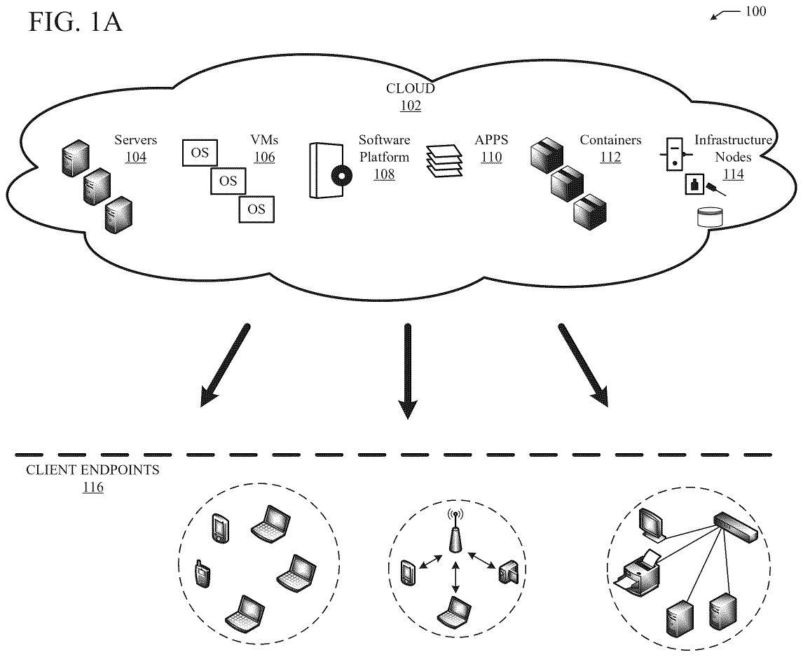

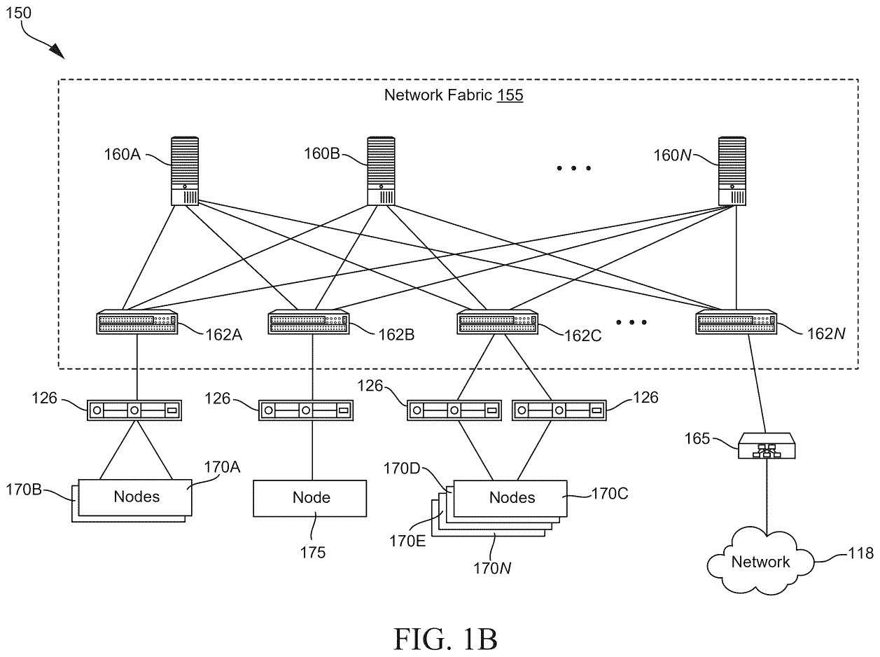

FIG. 1A illustrates a diagram of an example cloud computing architecture 100. The architecture can include a cloud 102. The cloud 102 can include one or more private clouds, public clouds, and/or hybrid clouds. Moreover, the cloud 102 can include cloud elements 104-114. The cloud elements 104-114 can include, for example, servers 104, virtual machines (VMs) 106, one or more software platforms 108, applications or services 110, software containers 112, and infrastructure nodes 114. The infrastructure nodes 114 can include various types of nodes, such as compute nodes, storage nodes, network nodes, management systems, etc.

The cloud 102 can provide various cloud computing services via the cloud elements 104-114, such as software as a service (SaaS) (e.g., collaboration services, email services, enterprise resource planning services, content services, communication services, etc.), infrastructure as a service (IaaS) (e.g., security services, networking services, systems management services, etc.), platform as a service (PaaS) (e.g., web services, streaming services, application development services, etc.), and other types of services such as desktop as a service (DaaS), information technology management as a service (ITaaS), managed software as a service (MSaaS), mobile backend as a service (MBaaS), etc.

The client endpoints 116 can connect with the cloud 102 to obtain one or more specific services from the cloud 102. The client endpoints 116 can communicate with elements 104-114 via one or more public networks (e.g., Internet), private networks, and/or hybrid networks (e.g., virtual private network). The client endpoints 116 can include any device with networking capabilities, such as a laptop computer, a tablet computer, a server, a desktop computer, a smartphone, a network device (e.g., an access point, a router, a switch, etc.), a smart television, a smart car, a sensor, a GPS device, a game system, a smart wearable object (e.g., smartwatch, etc.), a consumer object (e.g., Internet refrigerator, smart lighting system, etc.), a city or transportation system (e.g., traffic control, toll collection system, etc.), an internet of things (IoT) device, a camera, a network printer, or any smart or connected object (e.g., smart home, smart building, smart retail, smart glasses, etc.), and so forth.

In some cases, one or more embodiments, components, devices, nodes, systems, instances, and/or portions of the example cloud 102 can be implemented by and/or in a cloud network or datacenter. For example, any portion (or all) of the network 118, any of the content servers 120 (or all), and/or any of the system servers 126 (or all) can be implemented by and/or in a cloud network or datacenter. An example network architecture that can be used to implement any such network or datacenter (or any portion thereof), is shown in FIG. 1B and further described below.

FIG. 1B is a block diagram illustrating an example network architecture 150 that can be used to implement one or more embodiments, components, devices, nodes, systems, instances, and/or portions of the example cloud computing architecture 100, according to some examples of the present disclosure. The example network architecture 150 in FIG. 1B can represent, implement, deploy, host, support, include and/or provide the infrastructure for (or a portion of the infrastructure for) a datacenter (e.g., a cloud datacenter, an on-premises datacenter, a hybrid datacenter including private and public datacenters or datacenter portions, etc.), a network infrastructure, and/or any network environment (or portion thereof) such as, for example and without limitation, a cloud network/environment, a campus network/environment, an enterprise network/environment, an on-premises network/environment, a private network/environment, a public network/environment, a hybrid network/environment (e.g., a network/environment including both private and public networks/environments or portions thereof), and/or the like.

In some examples, the example network architecture 150 can host, implement, deploy, provide (e.g., provide the infrastructure for or a portion of the infrastructure for), support, and/or run/execute one or more applications, virtual machines (VMs), software containers, software tools, software functions, software algorithms, software models (e.g., artificial intelligence and machine learning models, software models implementing one or more classical algorithms, etc.), software applications, software packages, domains, databases, networks, services, workloads, service chains, functions, controllers, virtual network functions (VNFs), servers, drivers, hardware and/or software resources, software and/or hardware devices, software and/or hardware nodes, networking elements, serverless environments, serverless functions, cloud services and/or applications (e.g., software-as-a-service, function-as-a-service, infrastructure-as-a-service, platform-as-a-service, cloud applications, and/or any other cloud services and/or applications), execution environments, storage systems, processing/compute systems, memory systems, software and/or network sites, software policies, virtual/logical networks, overlay networks, software-defined networks (SDNs), interfaces, and/or any other code, component, element, application, service, etc.

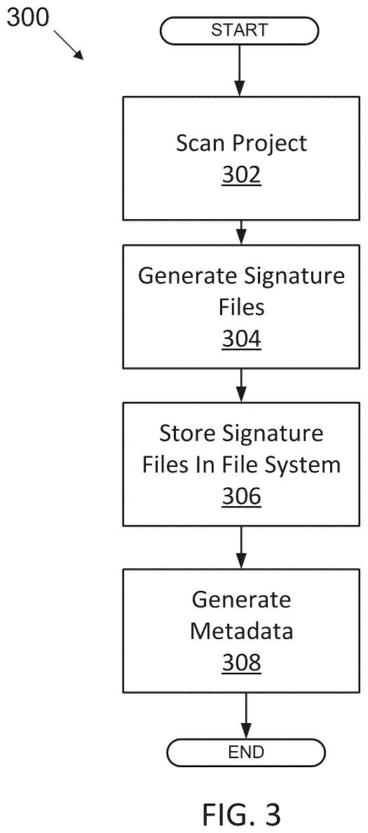

For example, the network architecture 150 can include, represent, implement, support, run, host, and/or provide the infrastructure for (or a portion of the infrastructure for) a datacenter, network (e.g., a cloud or cloud network, an on-premises network, a private network, a public network, a hybrid network, etc.), network infrastructure, and/or network environment used to host, implement, support, deploy, provide, and/or run quality control workloads/nodes, such as the worker nodes and the master node shown in FIG. 3 (and further described below). In such examples, the master node and each of the worker nodes can implement, include, represent, support, run, host, and/or provide one or more software applications/services, software systems, software packages, software modules, software units, software tools, interfaces, software/application code, functions, virtual environments, virtual applications, execution environments, virtualization elements (e.g., operating system-level virtualization elements, application-level virtualization elements, etc.), platforms, and/or any other components. In some cases, the master node and/or one or more of the worker nodes (or all) can each host and run one or more software containers, VMs, VNFs, applications (e.g., container applications, VM applications, and/or any other software applications), operating systems (OSs), functions, tools, and/or any other execution environment, code, tool, component, element, and/or package.

As shown in FIG. 1B, the network architecture 150 can include a network fabric 155. The network fabric 155 can include and/or represent the physical layer (e.g., underlay) and/or infrastructure of the network architecture 150. In some cases, the network fabric 155 can represent a data center(s) of one or more networks such as, for example, one or more cloud networks. The network fabric 155 can include network devices 160A-N (collectively referred to as “network devices 160” hereinafter) and network devices 162A-N (collectively referred to as “network devices 162” hereinafter), which are interconnected to route, relay, forward, and/or switch traffic in the network fabric 155. In some examples, the network devices 160 and the network devices 162 can include, implement, represent, and/or operate as switches (e.g., Layer 2 and/or Layer 3 switches, aggregation switches, ingress and/or egress switches, top-of-rack (ToR) switches, core switches, spine switches, leaf switches, etc.), routers, hubs, bridges, gateways, provider edge devices, firewalls, network controllers, and/or any other type of networking devices. In FIG. 1B, the network fabric 155 includes or implements a spine-leaf topology. In such examples, the network devices 160 can represent spine nodes (e.g., spine switches or routers) and the network devices 162 can represent leaf nodes (e.g., leaf switches or routers). In other examples, the network fabric 155 can alternatively or additionally include or implement any other network topology.

The network devices 160 are interconnected with the network devices 162, and the network devices 162 can connect the network 118, the system servers 126 (e.g., including QC system(s) 130 and configuration system(s) 132), the network device 165, the nodes 170, and/or the node 175 with any portion of the network fabric 155 (e.g., including each other), the media device(s) 106, the content servers 120, an external network(s), a network overlay(s), a logical network(s), a network portion(s) or branch/branches, an external device(s), a service chain(s), a data center(s), a cloud network(s), and/or any other network(s) and/or compute/network element(s). In some cases, the network fabric 155 can include, host, and/or implement a network overlay(s) or logical network(s) that includes or implements one or more application services, servers, VMs, software containers, virtual resources (e.g., storage, memory, processors, network interfaces, virtual tools, execution environments, etc.), workloads, functions, virtual networks, hardware and/or software resources, and/or any other element(s).

Network connectivity in the network fabric 155 can flow from the network devices 160 to the network devices 162, and vice versa. The network devices 162 can route, switch, relay, forward, and/or bridge network traffic to and from other portions of the network fabric 155, other networks, e.g. network 118, various network elements, the network device 165, the nodes 170, the node 175, external client devices (e.g., clients devices external to the network fabric 155), data centers, clouds, tunnels, software-defined networks (SDNs) and/or SDN branches, on-premises networks, cloud tenants, cloud customers, applications, and/or any other network element. Thus, the network devices 162 can connect networks and network elements of the network fabric 155 with each other and with other networks and network elements.

In FIG. 1B, the system servers 126 can include or represent computer servers. Each of the system servers 126 can host, include, implement, and/or run one or more applications, functions, services, VMs, software containers, service chains, workloads, AI/ML models, algorithms, resources, cloud appliances, and/or any other software. In some cases, the system servers 126 connected to the network devices 162 can encapsulate and decapsulate packets to and from the network devices 162. For example, the system servers 126 can include, host, implement and/or operate one or more virtual routers, switches, gateways, endpoints, and/or network devices for tunneling packets between an overlay or logical layer hosted by, or connected to, the system servers 126 and an underlay layer represented by or included in the network fabric 155.

As shown in FIG. 1B, the system servers 126 can host, include, run, operate, and/or implement the nodes 170 and the node 175. In some examples, the nodes 170 and the node 175 can represent cloud instances. For example, in some cases, the nodes 170 and the node 175 can each represent a virtual server and/or environment (e.g., a VM, a software container, etc.) that uses compute, memory, storage, and/or networking resources on the cloud (e.g., network architecture 150) for respective workloads. In some embodiments, the nodes 170 and/or the node 175 can perform parallel computing using, for example, multithreading. Each of the nodes 170 and/or the node 175 can include, host, implement, run, operate, and/or represent one or more server applications, software containers, VMs, software, services, AI/ML models, algorithms, cloud appliances, software functions, service chains, workloads, server-side functions, processing resources, computers, and/or any other software and/or hardware component.

For example, in some cases, each of the nodes 170 and/or the node 175 can represent a node instance that includes, implements, hosts, and/or runs a software container(s). The software container associated with a node can provide, run, deploy, include, operate, represent, and/or implement an execution environment(s), a workload(s), an application(s), software, an AI/ML model(s), an algorithm(s), a driver(s), a computer service(s), a software model(s) and/or algorithm(s), a function(s), a software library/libraries, a software tool(s), a software/cloud appliance(s), a software component(s), and/or any other computing element(s). In some cases, the nodes 170 and the node 175 can represent cloud node instances running respective computing environments, such as software containers or VMs. Each VM can include software, services, drivers, applications, libraries, functions, virtualized resources (e.g., processors, memory, storage, network interfaces, etc.), and/or workloads installed, implemented, included, and/or running/executed on a guest operating system (OS) associated with the VM.

The network architecture 150 can deploy, run, implement, host, and/or support various resources (e.g., hosts, applications, services, functions, VMs, software containers, workloads, cloud appliances, service chains, hardware and/or software resources, AI/ML models, algorithms, application platforms, operating systems, etc.) using the system servers 126, the network fabric 155, the network devices 160, the network devices 162, the network device 165, the nodes 170, the node 175, and the network 118.

In some cases, the network architecture 150 can implement and/or can be part of one or more cloud networks and can provide one or more cloud computing services such as, for example and without limitation, cloud storage, serverless computing, software-as-a-service (SaaS) (e.g., streaming services, content delivery services, video services, Internet content services, application services, conferencing services, etc.), infrastructure-as-a-service (IaaS), platform-as-a-service (PaaS) (e.g., web services, streaming services, content delivery services, content library services, conferencing services, video services, Internet content services, sharing and/or collaboration services, etc.), function-as-a-service (FaaS), and/or any other types of services such as desktop-as-a-service (DaaS), information technology management-as-a-service (ITaaS), managed software-as-a-service (MSaaS), mobile backend-as-a-service (MBaaS), etc.

The network architecture 150 described above illustrates a non-limiting example network architecture provided herein for explanation purposes. It should be noted that other network architectures can be implemented in other examples and are also contemplated herein. One of ordinary skill in the relevant art(s) will recognize in view of the disclosure that other network architectures can be used to implement one or more of the concepts, systems, techniques, devices, software, applications, methods, embodiments, elements, examples, and/or components disclosed herein.

Various embodiments of the subject technology can be implemented through the cloud computing architecture 100 shown in FIG. 1A and the network architecture 150 shown in FIG. 1B. In particular, just-in-time signature loading and other applicable applications can be implemented through the architectures 100 and 150 for performing selective loading of one or more specific cryptographic signatures needed to authenticate a software asset being loaded/executed during runtime of an application associated with the software asset.

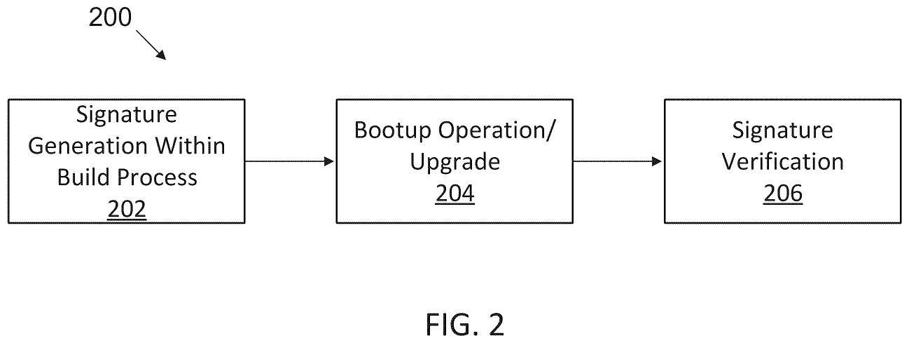

FIG. 2 illustrates a block diagram of an example process 200 for performing just-in-time signature loading, according to some examples of the present disclosure. The modules in process 200 can be performed in any applicable order or individually as single processes. In some examples, during build time, the process 200 can start at module 202 by generating cryptographic signatures of one or more software assets (e.g., files, modules, functions, code portions, scripts, etc.) that can be used to verify the integrity and authenticity of the one or more software assets. For example, cryptographic signatures can be generated to verify the integrity and authenticity of the software assets before loading or running the software assets.

Signatures can be generated for plugin files and stored in a file that can include a format (e.g., PluginId-sigSysId1: sigSysId2 . . . , etc.) under a plugin's update folder during build time. In some examples, this can be done using a code-signing-maven plugin. In some examples, during build time, de-centralized signature folders can be used for each plugin. Each plugin can have its own signature folder (e.g., if/com.glide.code_signing.signatures/update, etc.), and signatures can be consolidated to one or more signature folders. In various embodiments, signatures can be consolidated from different types of signature folders. Therefore, at module 202, one or more signatures can be generated during the build time of the application and stored in the file system.

In some examples, one or more metadata files can also be generated for the one or more signatures that can be used to later selectively retrieve signatures on demand. The metadata file can comprise one or more pointers that can uniquely identify the signature. For example, software assets listed within the metadate file can include a unique identifier indicating the location of the signature needed to verify that software asset. The details of the operation of signature generation module 202 are explained in more detail with regard to the description of FIG. 3 below.

Once the cryptographic signatures of the one or more software assets, as well as the metadata file, have been generated at module 202, the process 200 can continue to module 204. At module 204, the metadata file created at module 202 (e.g., sn_plugin_signature_metadata.xml) can be loaded during either a bootup operation or an application upgrade. In some examples, bootup operations can create a new instance of an application, and in some examples an application upgrade can include updating from a previous software version to a newer software version. Rather than loading all the signature files at a bootup operation or during the application upgrade, the metafile can simply be loaded into a database. This way, the system can selectively load the specific signatures as needed during runtime by using the unique identifiers within the metadata file (as explained with regard to module 206 below). This can be done in contrast to loading all the signatures associated with the application during build time (including any signatures that may not be needed to run a particular instance or portion of the application).

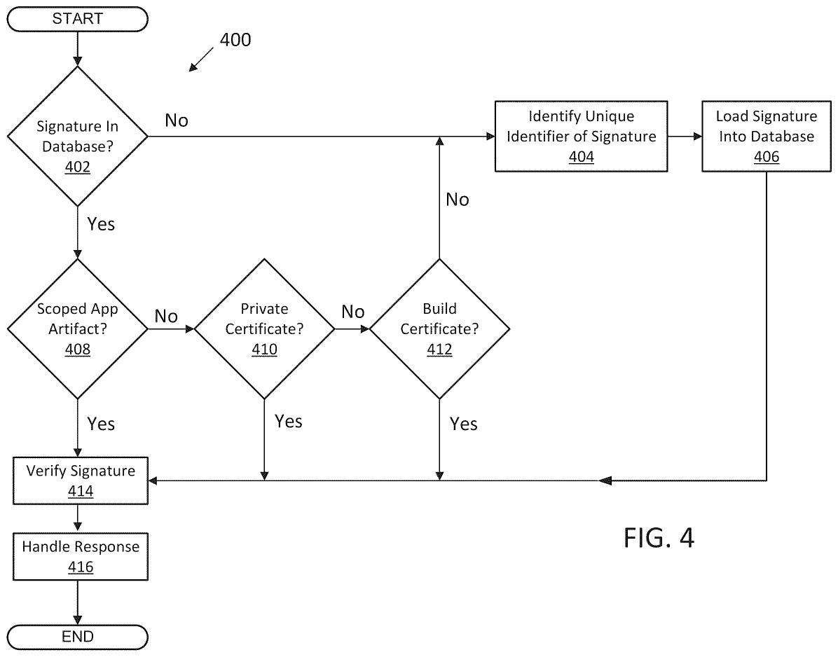

Once the metadata file has been loaded into the database (during a bootup operation or upgrade, for example), the process 200 can continue to module 206. At module 206, one or more signatures can be selectively loaded as needed during runtime. For example, during runtime, the application can encounter a software asset that needs to be verified. The process 200 can determine whether the signature associated with that software asset has been loaded and if so it can be verified. In some examples, the process 200 can determine that the signature associated with a software asset has not been loaded, and can reference the metadata file to locate the unique identifier associating the software asset with the location of the signature in the file system. Using this unique identifier, the process 200 can locate the signature and subsequently verify the software asset based on the located signature. This process of selective signature verification is explained with more detail with regard to the description of FIG. 4, below.

FIG. 3 illustrates a block diagram of an example process 300 for generating cryptographic signatures of one or more software assets (e.g., files, modules, functions, code portions, scripts, etc.) that can be used to verify the integrity and authenticity of the one or more software assets, according to some examples of the present disclosure. In some examples, the process 300 described with reference to FIG. 3 can occur during build time of the application. At module 302, during build time, the project can be scanned so that all software assets that require signature verification can be collected.

At module 304, also during build time, signature files can be generated for each software asset that was identified and collected at module 302. In some examples, each signature for each software asset file can be generated asynchronously.

At module 306, the signatures generated at module 304 can be stored in the file system, e.g. packaged as part of a JAR file, rather than loading them directly into the database. This is technically advantageous as the process of loading all signatures into the database during runtime can reduce performance of the application, as it introduces delays in the loading and verification process. Further, a large number of signatures may consume an excessive amount of storage space. Therefore, it is contemplated that the signatures generated at module 304 are stored in the file system at module 306 (rather than directly loaded into the database). In some examples, the signatures can be stored in a predetermined file pattern structure for ease of retrieval.

At module 308, a metadata file can be created that associates each generated signature with the related software asset using, for example, a unique identifier. In some examples, these unique identifiers located within the metadata file can be used to later selectively load signatures, as explained below with reference to FIG. 4. In some examples, the process 300 is completed during the build time of the application.

FIG. 4 illustrates a block diagram of an example process 400 for selective signature verification, according to some examples of the present disclosure. The process 400 for selective signature verification can occur during the run time of the application. This is technically advantageous as it can obviate the need to load all the signatures to the database that can introduce delays in the loading and verification process.

At decision point 402, the process 400 can include determining whether one ore more signatures needed to verify a software asset is loaded in the database. For example, as the application runs, it can encounter software assets that require signature verification. However, since not all signatures are loaded into the database after signature generation (see FIG. 3), the process 400 can determine whether a required signature exists in the database. If it is determined at decision point 402 that the required signature does not exist in the database, the process 400 continues to module 404, where the metadata file created in FIG. 3, for example, can be referenced to identify the unique identifier of the signature related to the software asset.

Next, at module 406, the signature that is identified in module 404 can be loaded into the database and verified (at module 414). If it is determined at decision point 402 that the required signature exists in the database, then the process 400 continues to decision point 408 where it is determined whether the software asset requiring verification is a scoped application artifact. If it is determined at decision point 408 that the software asset requiring verification is a scoped application artifact, the signature in the database can be verified (at module 414). On the other hand, if it is determined at decision point 408 that the software asset requiring verification is not a scoped application artifact, the process 400 continues to decision point 410 where it can be determined whether a private certificate exists for the software asset.

If it is determined that a private certificate exists for the software asset, the signature can be verified (at module 414). On the other hand, if it is determined that a private certificate does not exist for the software asset, the process 400 continues to decision point 412 where it is determined whether the software asset is associated with a build certificate. If it is determined that a build certificate exists for the software asset, the signature can be verified (at module 414). On the other hand, if it is determined that a build certificate does not exist for the software asset, the process 400 continues to the selective signature loading process that beings at module 404. Therefore, all software assets requiring verification can be verified using signatures whether the signature was loaded into the database during build time or not. Once one or more signatures are verified at module 414, the process 400 continues to module 416 where the application can handle the user response as necessary.

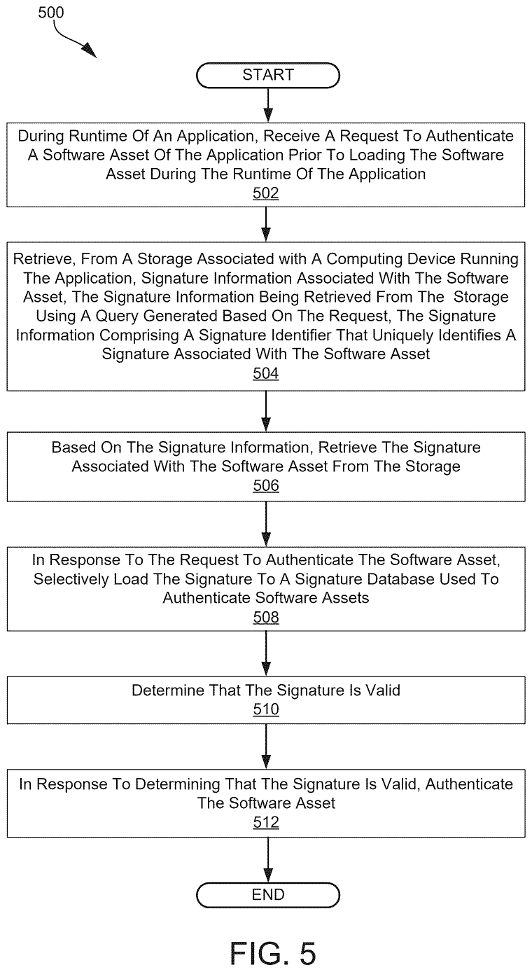

FIG. 5 illustrates a process 500 for performing just-in-time signature loading to selectively load one or more specific cryptographic signatures requested to authenticate a software asset. At module 502, the process 500 can include, during runtime of an application, receiving a request to authenticate a software asset of the application prior to loading the software asset during the runtime of the application. As discussed above, the signatures generated at build time (for example, module 304 of FIG. 3) can be stored in the file system, rather than loaded into the database during run time. Storing the signatures in the file system, rather than loading them all into the database is technically advantageous because the process of loading all signatures into the database during runtime can reduce performance of the application, as it introduces delays in the loading and verification process. Further, this process improves performance of the application, reduces latencies in authenticating software assets being loaded/executed, and reduces the storage space used to store cryptographic signatures in the database when running the application, all without compromising security when running the application. Therefore, one or more signatures generated during build time can be stored in the file system (rather than directly loaded into the database). Thus, during operation, the application can encounter a software asset that requests a signature verification that has not yet been loaded into the database.

At module 504, the process 500 can include retrieving, from a storage associated with a computing device running the application, signature information associated with the software asset, the signature information being retrieved from the storage using a query generated based on the request, the signature information comprising a signature identifier that uniquely identifies a signature associated with the software asset. As discussed above, a metadata file can be created during build time that associates each generated signature with the related software asset using, for example, a unique identifier. The metadata file can be stored in the file system and queried when a signature verification is requested, but the signature has not yet been loaded into the database. Storing unique identifiers that point to signatures within the metadata file is technically advantageous because it permits access to requested signatures without storing the signatures themselves all directly in the database. This technique further improves performance of the application, reduces latencies in authenticating software assets being loaded/executed, and reduces the storage space used to store cryptographic signatures in the database when running the application, all without compromising security when running the application.

At module 506, the process 500 can include, based on the signature information, retrieving the signature associated with the software asset from the storage. For example, the process can include using the unique identifier contained in the metadata to query the file system to identify the signature associated with the software asset. At module 508, the process 500 can include, in response to the request to authenticate the software asset, selectively loading the signature to an application database used to authenticate software assets. For example, as discussed above with reference to FIG. 4 (at module 406), the signature that is identified in module 404 can be loaded into the database. Additionally, it is also contemplated that signatures can be loaded into the database in baches of more than one signature as discussed above. Selectively loading the signature is technically advantageous because it avoids loading all cryptographic signatures to the database during runtime, which can reduce performance of the application, as it introduces delays in the loading and verification process.

At module 510, the process 500 can include determining that the signature is valid. For example, as discussed above with reference to FIG. 4 (at module 406), the signature that is identified in module 404 can be loaded into the database and verified (at module 414) to be a valid signature. At module 510, the process 500 can include, in response to determining that the signature is valid, authenticating the software asset. For example, a valid signature can indicate that the software is authentic.

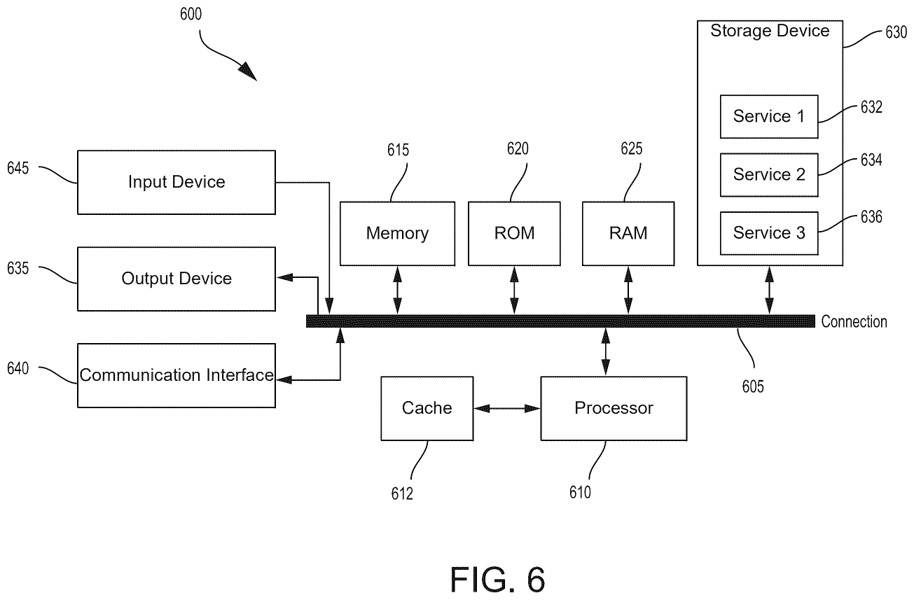

FIG. 6 illustrates an example processor-based system with which some embodiments of the subject technology can be implemented. For example, processor-based system 600 can be any computing device making up, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 600 includes at least one processing unit (Central Processing Unit (CPU) or processor) 610 and connection 605 that couples various system components including system memory 615, such as Read-Only Memory (ROM) 620 and Random-Access Memory (RAM) 625 to processor 610. Computing system 600 can include a cache of high-speed memory 612 connected directly with, in close proximity to, or integrated as part of processor 610.

Processor 610 can include any general-purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 630 can include software services, servers, services, etc., that when the code that defines such software is executed by the processor 610, it causes the system 600 to perform a function. In some embodiments, a hardware service that performs a particular function can include the software component stored in a computer-readable medium in connection with the necessary hardware components, such as processor 610, connection 605, output device 635, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### Selected Examples

Illustrative examples of the disclosure include:

Embodiment 1. A computer-implemented method comprising: during runtime of an application: receiving a request to authenticate a software asset of the application prior to loading the software asset during the runtime of the application; retrieving, from a storage associated with a computing device running the application, signature information associated with the software asset, the signature information being retrieved from the storage using a query generated based on the request, the signature information comprising a signature identifier that uniquely identifies a signature associated with the software asset; based on the signature information, retrieving the signature associated with the software asset from the storage; in response to the request to authenticate the software asset, selectively loading the signature to an application database used to authenticate software assets; determining that the signature is valid; and in response to determining that the signature is valid, authenticating the software asset.

Embodiment 2. The computer-implemented method of Embodiment 1, wherein the storage comprises a filesystem associated with the computing device, wherein the signature information further comprises a component identifier that uniquely identifies a software component associated with the software asset, and wherein retrieving the signature is based on the signature identifier and the component identifier.

Embodiment 3. The computer-implemented method of either of Embodiments 1 or 2, further comprising: after receiving the request and prior to retrieving the signature information from the storage, determining that the signature associated with the software asset is not in the application database; and based on determining that the signature is not in the application database, retrieving the signature information from the storage and loading only the signature to the application database.

Embodiment 4. The computer-implemented method of Embodiment 3, further comprising: loading a metadata content item identifying the signature associated with the software asset to the storage, the metadata content item being loaded to the storage during at least one of a build time of the application, an upgrade of the application, and a launch of a restored version of the application; retrieving the signature information from the metadata content item loaded to the storage, the signature information indicating a storage location of the signature; and retrieving the signature from the storage location.

Embodiment 5. The computer-implemented method of any of Embodiments 1 through 4, wherein retrieving the signature from the storage comprises retrieving the signature from a metadata content item comprising metadata mapping signature identifiers to component identifiers, and wherein the software asset comprises at least one of a portion of the software component, code implemented by the software component, and code triggered by the software component during execution of the software component.

Embodiment 6. The computer-implemented method of Embodiment 5, further comprising: identifying software assets of the application selected for signing and verification based on one or more selection cues; generating signatures associated with the software assets, the signatures comprising the signature associated with the software asset; generating the signature identifiers for the signatures, wherein each respective signature identifier from the signature identifiers uniquely identifies a corresponding signature from the signatures, and wherein each respective signature identifier is generated based on one or more features of a respective software asset associated with the corresponding signature; and based on the signature identifiers, generating the metadata content item during a build time of the application, the metadata content item mapping the signature identifiers with respective component identifiers from the component identifiers, the component identifiers corresponding to software components associated with the application.

Embodiment 7. The computer-implemented method of Embodiment 6, wherein the one or more features of the respective software asset comprise at least one of an identifier of the respective software asset, a functionality of the respective software asset, data of the respective software asset, and an indication of a data structure containing the data of the respective software asset.

Embodiment 8. The computer-implemented method of any of Embodiments 1 through 7, further comprising: during runtime of the application: receiving an additional request to authenticate an additional software asset of the application prior to loading the additional software asset; determining that a first respective signature of the additional software asset is in the application database; and in response to determining that the first respective signature of the additional software asset is in the application database, determining whether to validate the first respective signature from the database or retrieve a second respective signature of the additional software asset from the storage and validate the second respective signature.

Embodiment 9. The computer-implemented method of any of Embodiments 1 through 8, further comprising: in response to authenticating the software asset, loading the software asset during runtime of the application.

Embodiment 10. A system comprising: one or more processors; and at least one computer-readable storage medium having stored therein instructions which, when executed by the one or more processors, cause the one or more processors to: during runtime of an application: receive a request to authenticate a software asset of the application prior to loading the software asset during the runtime of the application; retrieve, from a storage associated with a computing device running the application, signature information associated with the software asset, the signature information being retrieved from the storage using a query generated based on the request, the signature information comprising a signature identifier that uniquely identifies a signature associated with the software asset; based on the signature information, retrieve the signature associated with the software asset from the storage; in response to the request to authenticate the software asset, selectively load the signature to an application database used to authenticate software assets; determine that the signature is valid; and in response to determining that the signature is valid, authenticate the software asset.

Embodiment 11. The system of Embodiment 10, wherein the storage comprises a filesystem associated with the computing device, wherein the signature information further comprises a component identifier that uniquely identifies a software component associated with the software asset, and wherein retrieving the signature is based on the signature identifier and the component identifier.

Embodiment 12. The system of either of Embodiments 10 or 11, wherein the instructions are further configured to cause the one or more processors to: after receiving the request and prior to retrieving the signature information from the storage, determine that the signature associated with the software asset is not in the application database; and based on determining that the signature is not in the application database, retrieve the signature information from the storage and loading only the signature to the application database.

Embodiment 13. The system of Embodiment 12, wherein the instructions are further configured to cause the one or more processors to: load a metadata content item identifying the signature associated with the software asset to the storage, the metadata content item being loaded to the storage during at least one of a build time of the application, an upgrade of the application, and a launch of a restored version of the application; retrieve the signature information from the metadata content item loaded to the storage, the signature information indicating a storage location of the signature; and retrieve the signature from the storage location.

Embodiment 14. The system of any of Embodiments 10 through 13, wherein retrieving the signature from the storage comprises retrieving the signature from a metadata content item comprising metadata mapping signature identifiers to component identifiers, and wherein the software asset comprises at least one of a portion of the software component, code implemented by the software component, and code triggered by the software component during execution of the software component.

Embodiment 15. The system of Embodiment 14, wherein the instructions are further configured to cause the one or more processors to: identify software assets of the application selected for signing and verification based on one or more selection cues; generate signatures associated with the software assets, the signatures comprising the signature associated with the software asset; generate the signature identifiers for the signatures, wherein each respective signature identifier from the signature identifiers uniquely identifies a corresponding signature from the signatures, and wherein each respective signature identifier is generated based on one or more features of a respective software asset associated with the corresponding signature; and based on the signature identifiers, generate the metadata content item during a build time of the application, the metadata content item mapping the signature identifiers with respective component identifiers from the component identifiers, the component identifiers corresponding to software components associated with the application.

Embodiment 16. The system of Embodiment 15, wherein the one or more features of the respective software asset comprise at least one of an identifier of the respective software asset, a functionality of the respective software asset, data of the respective software asset, and an indication of a data structure containing the data of the respective software asset.

Embodiment 17. The system of any of Embodiments 10 through 16, wherein the instructions are further configured to cause the one or more processors to: during runtime of the application: receive an additional request to authenticate an additional software asset of the application prior to loading the additional software asset; determine that a first respective signature of the additional software asset is in the application database; and in response to determining that the first respective signature of the additional software asset is in the application database, determine whether to validate the first respective signature from the database or retrieve a second respective signature of the additional software asset from the storage and validate the second respective signature.

Embodiment 18. The system of any of Embodiments 10 through 17, wherein the instructions are further configured to cause the one or more processors to: in response to authenticating the software asset, load the software asset during runtime of the application.

Embodiment 19. A non-transitory computer-readable storage medium storing instructions for causing one or more processors to: during runtime of an application: receive a request to authenticate a software asset of the application prior to loading the software asset during the runtime of the application; retrieve, from a storage associated with a computing device running the application, signature information associated with the software asset, the signature information being retrieved from the storage using a query generated based on the request, the signature information comprising a signature identifier that uniquely identifies a signature associated with the software asset; based on the signature information, retrieve the signature associated with the software asset from the storage; in response to the request to authenticate the software asset, selectively load the signature to an application database used to authenticate software assets; determine that the signature is valid; and in response to determining that the signature is valid, authenticate the software asset.

Embodiment 20. The non-transitory computer-readable storage medium of Embodiment 19, wherein the storage comprises a filesystem associated with the computing device, wherein the signature information further comprises a component identifier that uniquely identifies a software component associated with the software asset, and wherein retrieving the signature is based on the signature identifier and the component identifier.

Embodiment 21. A system comprising means for performing a method according to any of Embodiments 1 through 9.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A computer-implemented method comprising:
during runtime of an application:
receiving a request to authenticate a software asset of the application prior to loading the software asset during the runtime of the application;
retrieving, from a storage associated with a computing device running the application, signature information associated with the software asset, the signature information being retrieved from the storage using a query generated based on the request, the signature information comprising a signature identifier that uniquely identifies a signature associated with the software asset;
based on the signature information, retrieving the signature associated with the software asset from the storage;
in response to the request to authenticate the software asset, selectively loading the signature to an application database used to authenticate software assets;
determining that the signature is valid; and
in response to determining that the signature is valid, authenticating the software asset.

2. The computer-implemented method of claim 1, wherein the storage comprises a filesystem associated with the computing device, wherein the signature information further comprises a component identifier that uniquely identifies a software component associated with the software asset, and wherein retrieving the signature is based on the signature identifier and the component identifier.

3. The computer-implemented method of claim 1, further comprising:
after receiving the request and prior to retrieving the signature information from the storage, determining that the signature associated with the software asset is not in the application database; and
based on determining that the signature is not in the application database, retrieving the signature information from the storage and loading only the signature to the application database.

4. The computer-implemented method of claim 3, further comprising:
loading a metadata content item identifying the signature associated with the software asset to the storage, the metadata content item being loaded to the storage during at least one of a build time of the application, an upgrade of the application, and a launch of a restored version of the application;
retrieving the signature information from the metadata content item loaded to the storage, the signature information indicating a storage location of the signature; and
retrieving the signature from the storage location.

5. The computer-implemented method of claim 1, wherein retrieving the signature from the storage comprises retrieving the signature from a metadata content item comprising metadata mapping signature identifiers to component identifiers, and wherein the software asset comprises at least one of a portion of the software component, code implemented by the software component, and code triggered by the software component during execution of the software component.

6. The computer-implemented method of claim 5, further comprising:
identifying software assets of the application selected for signing and verification based on one or more selection cues;
generating signatures associated with the software assets, the signatures comprising the signature associated with the software asset;
generating the signature identifiers for the signatures, wherein each respective signature identifier from the signature identifiers uniquely identifies a corresponding signature from the signatures, and wherein each respective signature identifier is generated based on one or more features of a respective software asset associated with the corresponding signature; and
based on the signature identifiers, generating the metadata content item during a build time of the application, the metadata content item mapping the signature identifiers with respective component identifiers from the component identifiers, the component identifiers corresponding to software components associated with the application.

7. The computer-implemented method of claim 6, wherein the one or more features of the respective software asset comprise at least one of an identifier of the respective software asset, a functionality of the respective software asset, data of the respective software asset, and an indication of a data structure containing the data of the respective software asset.

8. The computer-implemented method of claim 1, further comprising:
during runtime of the application:
receiving an additional request to authenticate an additional software asset of the application prior to loading the additional software asset;
determining that a first respective signature of the additional software asset is in the application database; and
in response to determining that the first respective signature of the additional software asset is in the application database, determining whether to validate the first respective signature from the database or retrieve a second respective signature of the additional software asset from the storage and validate the second respective signature.

9. The computer-implemented method of claim 1, further comprising:
in response to authenticating the software asset, loading the software asset during runtime of the application.

10. A system comprising:
one or more processors; and
at least one computer-readable storage medium having stored therein instructions which, when executed by the one or more processors, cause the one or more processors to:
during runtime of an application:
receive a request to authenticate a software asset of the application prior to loading the software asset during the runtime of the application;
retrieve, from a storage associated with a computing device running the application, signature information associated with the software asset, the signature information being retrieved from the storage using a query generated based on the request, the signature information comprising a signature identifier that uniquely identifies a signature associated with the software asset;
based on the signature information, retrieve the signature associated with the software asset from the storage;
in response to the request to authenticate the software asset, selectively load the signature to an application database used to authenticate software assets;
determine that the signature is valid; and
in response to determining that the signature is valid, authenticate the software asset.

11. The system of claim 10, wherein the storage comprises a filesystem associated with the computing device, wherein the signature information further comprises a component identifier that uniquely identifies a software component associated with the software asset, and wherein retrieving the signature is based on the signature identifier and the component identifier.

12. The system of claim 10, wherein the instructions are further configured to cause the one or more processors to:
after receiving the request and prior to retrieving the signature information from the storage, determine that the signature associated with the software asset is not in the application database; and
based on determining that the signature is not in the application database, retrieve the signature information from the storage and loading only the signature to the application database.

13. The system of claim 12, wherein the instructions are further configured to cause the one or more processors to:
load a metadata content item identifying the signature associated with the software asset to the storage, the metadata content item being loaded to the storage during at least one of a build time of the application, an upgrade of the application, and a launch of a restored version of the application;
retrieve the signature information from the metadata content item loaded to the storage, the signature information indicating a storage location of the signature; and
retrieve the signature from the storage location.

14. The system of claim 10, wherein retrieving the signature from the storage comprises retrieving the signature from a metadata content item comprising metadata mapping signature identifiers to component identifiers, and wherein the software asset comprises at least one of a portion of the software component, code implemented by the software component, and code triggered by the software component during execution of the software component.

15. The system of claim 14, wherein the instructions are further configured to cause the one or more processors to:
identify software assets of the application selected for signing and verification based on one or more selection cues;
generate signatures associated with the software assets, the signatures comprising the signature associated with the software asset;
generate the signature identifiers for the signatures, wherein each respective signature identifier from the signature identifiers uniquely identifies a corresponding signature from the signatures, and wherein each respective signature identifier is generated based on one or more features of a respective software asset associated with the corresponding signature; and
based on the signature identifiers, generate the metadata content item during a build time of the application, the metadata content item mapping the signature identifiers with respective component identifiers from the component identifiers, the component identifiers corresponding to software components associated with the application.

16. The system of claim 15, wherein the one or more features of the respective software asset comprise at least one of an identifier of the respective software asset, a functionality of the respective software asset, data of the respective software asset, and an indication of a data structure containing the data of the respective software asset.

17. The system of claim 10, wherein the instructions are further configured to cause the one or more processors to:
during runtime of the application:
receive an additional request to authenticate an additional software asset of the application prior to loading the additional software asset;
determine that a first respective signature of the additional software asset is in the application database; and
in response to determining that the first respective signature of the additional software asset is in the application database, determine whether to validate the first respective signature from the database or retrieve a second respective signature of the additional software asset from the storage and validate the second respective signature.

18. The system of claim 10, wherein the instructions are further configured to cause the one or more processors to:
in response to authenticating the software asset, load the software asset during runtime of the application.

19. A non-transitory computer-readable storage medium storing instructions for causing one or more processors to:
during runtime of an application:
receive a request to authenticate a software asset of the application prior to loading the software asset during the runtime of the application;
retrieve, from a storage associated with a computing device running the application, signature information associated with the software asset, the signature information being retrieved from the storage using a query generated based on the request, the signature information comprising a signature identifier that uniquely identifies a signature associated with the software asset;
based on the signature information, retrieve the signature associated with the software asset from the storage;
in response to the request to authenticate the software asset, selectively load the signature to an application database used to authenticate software assets;
determine that the signature is valid; and
in response to determining that the signature is valid, authenticate the software asset.

20. The non-transitory computer-readable storage medium of claim 19, wherein the storage comprises a filesystem associated with the computing device, wherein the signature information further comprises a component identifier that uniquely identifies a software component associated with the software asset, and wherein retrieving the signature is based on the signature identifier and the component identifier.
